(19) United States
(12) Patent Application Publication
(10) Pub. No.: US 2011/0041092 A1
(43) Pub. Date: Feb. 17, 2011

(54) Type of Graphical User Interface-Vertical Ribbon

(76) Inventor: Xuezhi Zhang, Guangzhou (CN)

Correspondence Address: Xuezhi Zhang, 402 Building 28, Cuishan Lantian Yan, Huanan Country Garden, Yingbin Road Panyu District, Guangzhou, Guangdong, 511442, CN

(21) Appl. No.: 12/783,554

(22) Filed: May 20, 2010

(30) Foreign Application Priority Data
Aug. 17, 2009 (CN) 200910041885.9

(51) Int. Cl. G06F 3/048

(52) U.S. Cl. 715/777

(57) ABSTRACT

A new type of graphical user interface-vertical ribbon relates to graphical user interface for computer software applications.

The present invention presents technical schemes for the design and implementation of ribbon graphical user interface as a vertically oriented ribbon graphical user interface situated vertically on the left and/or right side of the software application window in order to make full use of the horizontal space of computer display screens thus increasing the actual working space for word and/or image processing software. The vertical ribbon graphical user interface is composed of one or two vertical ribbon bar inside which resides a plurality of stacked vertical ribbon tabs which contain a plurality of vertical ribbon panels arranged one by one vertically downwards, a quick access toolbar and an application button. Each vertical ribbon panel hosts a command group of ribbon command graphical interface elements with similar or related functionalities. The vertical ribbon tabs can be designed and implemented as vertically scrollable vertical ribbon tabs to host more vertical ribbon panels.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to the technical field of graphical user interface for software for computers and computing systems.

Menus and toolbars are graphical user interfaces widely used in computer software. A new type of graphical user interface, the ribbon, was introduced by Microsoft in its flagship product Office 2007 recently. The ribbon combines menu and toolbar together, situated horizontally across the top of the software application window just below and next to the caption bar and above the actual working area of the active document. Refer to FIG. 1 for an indicative diagram for the ribbon interface in Microsoft Office 2007. Examples of ribbons are disclosed in U.S. Patent Application Publication No. 2006/0036964 to J. C. Satterfield et al., U.S. Patent Application Publication No. 2007/0055943 to M. J. McCormack et al. and U.S. Patent Application Publication No. 2008/0244440 to W. Bailey et al.

The ribbon interface is consists of an application button, a quick access toolbar, a ribbon bar and a plurality of stacked ribbon tabs with tab headings. There are several ribbon panels in each ribbon tab. Each ribbon panel hosts a command group comprised of commands with similar functionality represented with ribbon command graphical interface elements such as buttons, combo boxes, list boxes, launch buttons and command galleries etc. There is a name label for the command group at the bottom of its host ribbon panel and a launch button at the bottom-right corner of the panel that can launch a pull-down menu, a dialog box or a property sheet. Refer to FIG. 1. There are also some additional ribbon tabs which are displayed only when certain conditions are satisfied, these ribbon tabs are called contextual ribbon tabs. The ribbon command graphical interface elements are designed with large icons and small icons. The command group and its host ribbon panel can automatically enlarge or shrink horizontally according to available horizontal space, they can shrink until there is only one column of ribbon command graphical interface elements or only one default button with the name of the command group if horizontal space is limited. The default button can expand to a command group when clicked.

The ribbon interface is large in height in order to hosts large icons for easy recognition of the commands. It occupies quite a big portion of the total height of the software application window on the screen. Take a standard 22 inch liquid crystal display as an example, the height of the ribbon interface makes up 20%-25% of the total height of the screen when the software application window is maximized. This reduces the actual working space inside the software application window quite substantially. As computer display screens are evolving towards wider and shorter, in particular the height is much smaller than the width for the newer standard 16:9 high definition high resolution screens, the ribbon interface situated across the top of the software application window takes up an even bigger portion of the smaller height of these newer screens. Refer to FIG. 1. Many image processing and/or drawing software employs roughly square document windows as their working space to keep the aspect ratio and to avoid image or graph deformation, the width of the actual working area will also decrease as the height decreases, this will result in further waste of more horizontal space. See FIG. 1.

### BRIEF SUMMARY OF THE INVENTION

Considering the fact that the width is larger than the height for computer display screens, the present invention designs and implements a vertical ribbon graphical user interface situated vertically on the left hand side and/or right hand side of the software application window between the caption bar at the top and the status bar at the bottom, thus increasing the actual working space of the software application window by making full use of the horizontal space of the display screen. Refer to FIG. 2.

### BRIEF DESCRIPTION OF THE DRAWINGS

FIG. 1 is an indicative diagram of the software application window for Microsoft Office 2007 showing the ribbon interface.

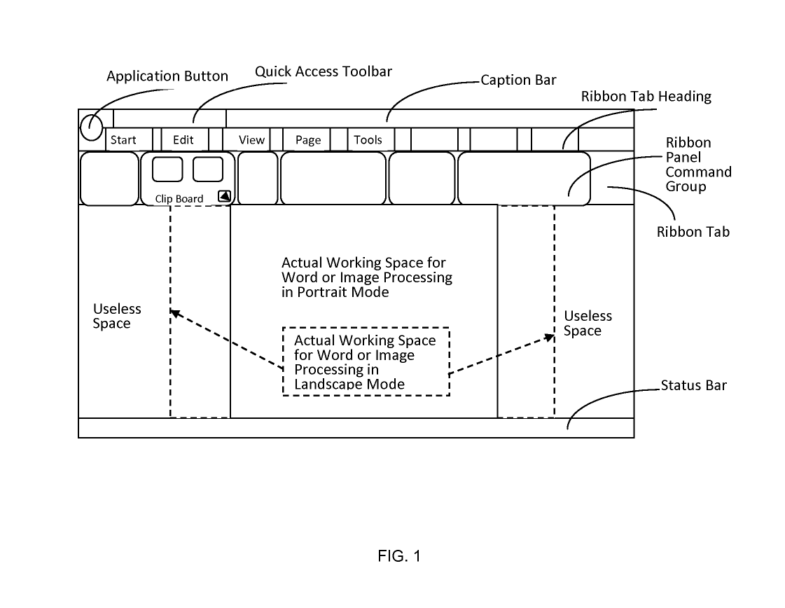

FIG. 2 is an indicative diagram of the software application window for the present invention showing the vertical ribbon interface.

FIG. 3 is an indicative diagram of the software application window for an embodiment of the vertical ribbon interface for the present invention.

### DETAILED DESCRIPTION OF THE INVENTION

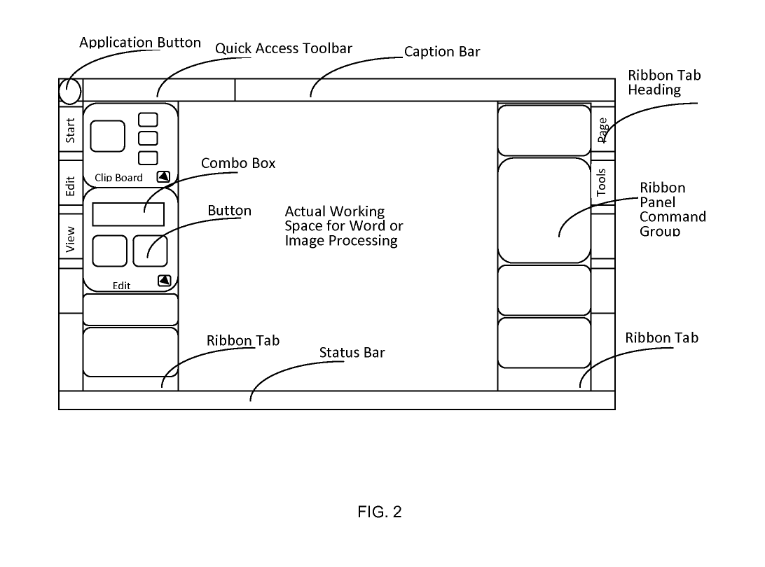

FIG. 2 shows an indicative diagram of the vertical ribbon interface in a software application window for the present invention. The ribbon interface is designed and implemented into a vertical ribbon interface and placed on either left or right vertical side of the software application window or on both left and right vertical sides of the software application window. The vertical ribbon interface is comprised of vertical ribbon bars, a plurality of stacked vertical ribbon tabs, a plurality of vertical ribbon panels inside each vertical ribbon tab, an application button and a quick access toolbar. The vertical ribbon bar is situated on either left or right side or on both left and right sides of the software application window between the caption bar at the top and the status bar at the bottom. The vertical ribbon tabs are ribbon tabs designed in a vertical orientation with vertical ribbon panels arranged one by one vertically downwards inside. They are stacked inside vertical ribbon bars with the tab headings disposed in the left most column of the vertical ribbon bar situated on the left side of the window or with the tab headings disposed in the right most column of the vertical ribbon bar situated on the right side of the window. The tab headings are vertically typeset to save horizontal space as shown in FIG. 2. The vertical ribbon panels are arranged one by one vertically downwards inside vertical ribbon tabs, their heights vary according to the number and sizes of the command graphical interface elements inside and their width can be set to be sufficient for two to four buttons with standard 32×32 pixel icons or one to two combo boxes and can be set beforehand in design. Each vertical ribbon panel hosts a command group consisting of commands with similar or related functionality represented with command graphical interface elements such as buttons, combo boxes or list boxes, launch buttons and/or command galleries etc. There is a label for the command group at the bottom of the vertical ribbon panel and a launch button at the bottom right corner, the launch button can pop-up a pull-down or pull-horizontally menu, dialog box or property sheet for the commands in the command group. The command graphical interface elements in the command group for the vertical ribbon panels are designed to have large and small icons, the vertical ribbon panels can enlarge by using the large icons or shrink by using the small icons according to available vertical space, the shrinkage can continue until the vertical ribbon panel reduces to a single row of command icons or just a single default button for the command group, the default button can launch into a command group with all the commands when clicked. The vertical ribbon tabs can also be designed as vertically scrollable ribbon tabs similar to a pull-down menu, this way, the vertical ribbon panels do not need to enlarge or shrink since vertical space is always sufficient through scrolling. The vertical ribbon interface can also have its own application button and quick access toolbar. The application button can be placed at the top left corner of the software application window next to the quick access toolbar placed in the left side of the caption bar as for horizontal ribbon interface. For vertical ribbon interface situated on the right side of the software application window, the application button can also be placed at the top right corner of the window next to the quick access toolbar placed in the right side of the caption bar. There can also be some contextual vertical ribbon tabs which are displayed under certain circumstances. The quick access toolbar can also be designed as a vertical toolbar placed on the outside of and next to the vertical ribbon. The vertical ribbon bar can be designed and implemented to be placed on the left and/or right frame of the software application window, i.e. on the non-client area of the window or in the client area inside the left and/or right frame of the window.

The present invention can be employed in any general purpose or special purpose computing environments or computing systems. Examples of applicable known computing systems, computing environments and/or computing configurations for the present invention include, but not limited to, personal computer, server computer, portable or laptop equipment, multiple processor systems, systems based on micro-processors, set top boxes, programmable consumer electronic appliances, network personal computers, small computers, large scale computers and distributed computing environments which contain any systems and/or equipments described above, etc.

The present invention put forth a vertical ribbon graphical user interface situated vertically on the left and/or right sides of the software application window. It makes full use of the horizontal space, thus greatly increasing the actual working space for image or word processing for software applications. The vertical ribbon interface is particularly suitable for software applications which uses block characters like Chinese characters as the display language for the graphical user interface.

### DETAILED DESCRIPTIONS OF AN EMBODIMENT

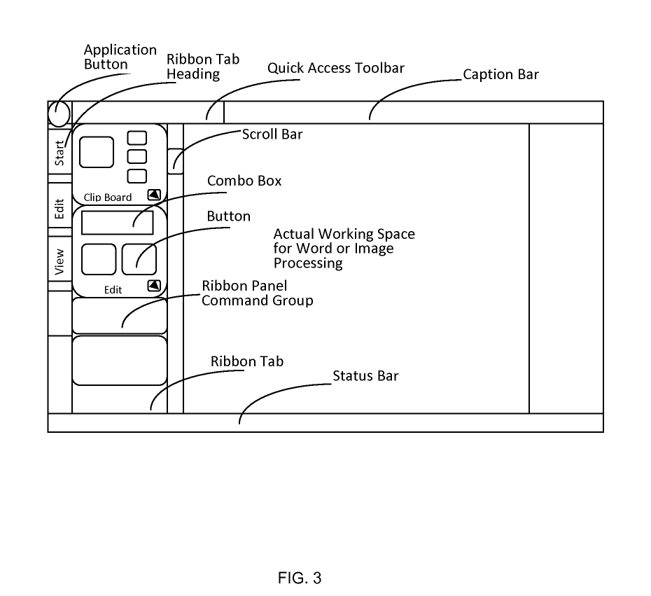

Further description on the technical scheme for the vertical ribbon graphical user interface will be given below with an embodiment of the present invention. FIG. 3 is an indicative diagram for an embodiment of the vertical ribbon graphical user interface for the present invention.

In the current embodiment of the present invention, the vertical ribbon bar is placed on the left side of the software application window, between the caption bar at the top and the status bar at the bottom; there is a plurality of stacked vertical ribbon tabs inside the vertical ribbon bar with ribbon tab headings disposed in the left-most column of the vertical ribbon bar and ribbon tab heading text vertically typeset. See FIG. 3. The vertical ribbon panels are arranged one by one downwards from the top in the vertical ribbon tabs, their heights vary according to the number and size of the command graphical interface elements for the command groups they represent. The application button is placed on the top-left corner of the software application window and the quick access toolbar is situated in the left side of the caption bar next to the application button. Refer to FIG. 3. The width of the vertical ribbon bar can be designed and set according to the width sufficient for the vertical ribbon panels inside to hold two to four standard large icon of 32×32 pixels or one to two combo boxes.

The vertical ribbon graphical user interface described above can be implemented with a series of related classes and/or interfaces. The main classes include: CVerticalRibbonBar, CVerticalRibbonTab, CVerticalRibbonPanel, CRibbonAppMainPanel, CRibbonItemBase, CRibbonButton derived from the CRibbonItemBase class and various ribbon command graphical interface elements derived from the CRibbonButton class such as CRibbonButtonGroup, CRibbonQuickAccessToolbar, CRibbonGallery, CRibbonCheckBox, CRibbonEdit, CRibbonComboBox, CRibbonListBox, CRibbonLaunchButton, CRibbonAppButton and CRibbonLabel etc.

The CRibbonItemBase class provides properties such as command ID, command description, command label, command prompt or tips and various command states etc. and function for the designation of the use of the large or small icons for the derived classes of the ribbon command graphical interface elements. The CRibbonButton class provides events and functions for pop-up menu and/or dialog box etc. for the derived classes of the ribbon command graphical interface elements. The CVerticalRibbonBar class represents the vertical ribbon graphical user interface inside which a plurality of stacked vertical ribbon tabs (CVerticalRibbonTab) are placed. A plurality of vertical ribbon panels (CVerticalRibbonPanel) can be added to each vertical ribbon tab. Each vertical ribbon panel contains a command group composed of various ribbon command graphical interface elements, a name label for the command group at its bottom and a launch button at the lower-right corner of the panel that can launch a pull-down or pull-horizontally menu, dialog box or property sheet. The vertical ribbon panels can enlarge vertically by using large icons for the ribbon command graphical interface elements or shrink vertically by using the small icons according to the available vertical space, the shrinkage can continue until the panels become single row of ribbon command graphical interface elements or single default buttons for the command groups if the vertical space is limited. The default button for a command group can launch the command group or pop-up a menu for the command group when clicked. The CRibbonAppMainPanel class provides the pull-down menu when the application button (CRibbonAppButton) is clicked. The CRibbonQuickAccessToolbar class implements the quick access toolbar.

One variation to the technical scheme for the above embodiment is to design the CVerticalRibbonTab as a vertically scrollable ribbon tab CVerticalScrollRibbonTab in the above embodiment, this way, the vertical ribbon panels (CVerticalRibbonPanel) inside do not need to provide the enlargement and shrinkage functionality since vertical space can always be sufficient through scrolling the vertical ribbon tab vertically.

The above embodiments are examples provided for general technicians in the field to realize the present invention. Technicians in the field can make changes or modifications to the embodiments described above in accordance with the creative thoughts of the present invention. Therefore the scope of the present invention will not be limited by the above embodiment, but will be extended to the maximum extent in accordance with the creative characteristics put forward in the claims section.

1. A new type of graphical user interface-vertical ribbon is characterized by the design and implementation of the ribbon graphical user interface into a vertically oriented ribbon graphical user interface situated vertically on the left side and/or right side of the software application window between the caption bar at the top and the status bar at the bottom of the window. The said vertical ribbon graphical user interface is composed of one or two vertical ribbon bar inside which resides a plurality of stacked vertical ribbon tabs which contain a plurality of vertical ribbon panels arranged one by one vertically downwards which host a command group of ribbon command graphical interface elements each, a quick access toolbar and an application button.

2. The said vertical ribbon as described in claim 1 can be placed on the left and/or right frame of the software application window, i.e. the non-client area of the window or placed inside the left and/or right frame of the software application window, i.e. the client area of the window.

3. The vertical ribbon bar as described in claim 1 is characterized by that the width of the ribbon bar can be set in design beforehand. Normally the width of the vertical ribbon bar can be designed to be sufficient to hosts two to four ribbon command buttons with standard 32×32 pixel icons or one to two combo boxes.

4. The vertical ribbon tab as described in claim 1 is characterized by that the ribbon tab heading is disposed in the left-most column of the vertical ribbon for vertical ribbon bar situated on the left side of the software application window and in the right-most column of the vertical ribbon for vertical ribbon bar situated on the right side of the software application window. The text for the ribbon tab heading is vertically typeset in the left most or right most column of the vertical ribbon to save horizontal space.

5. The vertical ribbon tab as described in claim 1 is further characterized by that it can be designed and implemented as a vertically scrollable vertical ribbon tab to host more vertical ribbon panels.

6. The vertical ribbon panels as described in claim 1 are characterized by that they are arranged one by one from the top vertically down inside vertical ribbon tabs, their heights vary according to the number and sizes of the command graphical interface elements contained. They can enlarge or shrink vertically according to available vertical space by using the large icon or small icons. The said shrinkage can continue until the vertical ribbon panels become default buttons if vertical space is limited. The default buttons can expand or launch into the command groups represented by the vertical ribbon panels when clicked.
